(19) United States
(12) Patent Application Publication
(10) Pub. No.: US 2017/0044421 A1
(43) Pub. Date: Feb. 16, 2017

(54) SOLID-STABILIZED EMULSION

(71) Applicant: Wintershall Holding GmbH, Kassel (DE)

(72) Inventors: Andrei-Nicolae PARVULESCU, Ruppertsberg (DE); Riichiro KIMURA, Jersey City, NJ (US); Stefam MAURER, Pudong (CN); Roelf-Peter BAUMANN, Mannheim (DE); Lorenz SIGGEL, Heidelberg (DE); Ulrich MÜLLER, Neustadt (DE)

(21) Appl. No.: 15/305,556

(22) PCT Filed: Apr. 20, 2015
(86) PCT No.: PCT/EP2015/058490

§ 371 Date: Oct. 20, 2016

(30) Foreign Application Priority Data
Apr. 22, 2014 (EP) 14165414.5

(51) Int. Cl. C09K 8/58

(52) U.S. Cl. CPC C09K 8/58; C09K 2208/10

(57) ABSTRACT

The present invention relates to an emulsion comprising: a) water, b) at least one crude oil and c) at least one layered double hydroxide of general formula (I), whereby the layered double hydroxide of general formula (I) is present in the form of solid particles. The present invention further relates to a process for the preparation of the emulsion and the use of the same.

### CROSS-REFERENCE TO RELATED APPLICATIONS

This application is a national stage application (under 35 U.S.C. §371) of PCT/EP2015/058490 filed Apr. 20, 2015, which claims benefit of European Application No. 14165414.5, filed Apr. 22, 2014, both of which are incorporated herein by reference in their entirety.

The present invention relates to an emulsion comprising: a) water, b) at least one crude oil and c) at least one layered double hydroxide of general formula (I), whereby the layered double hydroxide of general formula (I) is present in the form of solid particles. The present invention further relates to a process for the preparation of the emulsion and the use of the same.

Emulsions are known in the art and are commonly referred to as oil-in-water or water-in-oil emulsions. Emulsions generally have a limited stability, i.e. limited storage life time or shelf life time, and segregate or separate upon prolonged storage, and/or show rapid droplet growth or droplet size increase.

Oil-in-water emulsions have become important in the petroleum industry as a displacing fluid for enhanced oil recovery. When used as a displacing fluid, an emulsion is pumped into a wellbore and displaces oil in subterranean formations. However, an alternative approach to increase the amount of extracted oil would be to form an emulsion in situ in the subterranean formation. These emulsions should have a low viscosity and show high stability even at elevated temperatures in order to allow for easy recovery from the subterranean formation by pumping.

U.S. Pat. No. 6,988,550 discloses a method to prepare an oil-in-water emulsion in a subterranean formation in the presence of hydrophilic particles such as bentonite clay and kaolinite clay both of which comprise negatively charged layers and cations in the interlayer spaces.

Wang et al. (Langmuir 2008, 24, pages 10054-10061) disclose double phase inversion of emulsions containing layered double hydroxide particles induced by adsorption of sodium dodecyl sulfate. Therefore a liquid paraffin-water emulsion was investigated using layered double hydroxide (LDH) particles and sodium dodecyl sulfate (SDS) as emulsifiers. Both emulsifiers are well-known to stabilize oil-in-water (o/w) emulsions. A double phase inversion of the emulsion containing LDH particles is induced by the adsorption of SDS.

Zhe An et al. (Chemical Communications, 2013, vol. 49, pages 5912-5920) disclose layered double hydroxide-based catalysts with nanostructure design and catalytic performance. Layered double hydroxides (LDHs) are a class of clays with brucite-like layers and intercalated anions which have attracted increasing interest in the field of catalysis. Benefiting from the atomic-scale uniform distribution of metal cations in the brucite-like layers and the ability to intercalate a diverse range of interlayer anions, LDHs display great potential as precursors/supports to prepare catalysts, in that the catalytic sites can be preferentially orientated, highly dispersed, and firmly stabilized to afford excellent catalytic performance and recyclability.

US 2003/0139299 A1 discloses a solids-stabilized oil-in-water emulsion and a method for preparing the same. The oil-in-water emulsion is formed by combining oil, water, solid particles and a pH enhancing agent and mixing until the solid-stabilized oil-in-water emulsion is formed. The low viscosity oil-in-water emulsion can be used to enhance production of oil from subterranean reservoirs.

Han et al. (Colloid Polym Sci 274: 860-865 (1996)) disclose a study on the preparation and structure of positive sol composed of mixed metal hydroxide. Han et al. disclose the preparation of mixed metal hydroxide (MMH) positive sol by using the precipitation method.

Abend et al. (Colloid Polym Sci, 276: pages 730-737 (1998)) disclose a stabilization of emulsions by heterocoagulation of clay minerals and layered double hydroxides. The paraffin/water emulsions were stabilized by colloidal particles without surface active agents. Mixtures of two types of particles with opposite signs of charge were used: a layered double hydroxide (the hydroxide layers carry positive charges) and the clay mineral montmorillonite (the silicate layers carry negative charges). The emulsions were very stable and did not separate a coherent oil phase. The stability of the emulsion (no oil coalescence after centrifugation) was independent of the mixing ratio of both the compounds when the total solid content was >0.5%. Solid contents up to 2.0% were optimal.

Yang et al. (Journal of Colloid and Interface Science, 302 (2006) pages 159-169) disclose pickering emulsions stabilized solely by a layered double hydroxides particles and the effect of salt on emulsion formation and stability. The formation and stability of liquid paraffin-in-water emulsions stabilized solely by positively charged plate-like layered double hydroxides (LDHs) particles were described here. The effects of adding salt into LDHs dispersions on particle zeta potential, particle contact angle, particle adsorption at the oil-water interface and the structure strength of dispersions were studied. It was found that the zeta potential of particles gradually decreased with the increase of salt concentration, but the variation of contact angle with salt concentration was very small. The adsorption of particles at the oil-water interface occurred due to the reduction of particle zeta potential. The structural strength of LDHs dispersions was strengthened with the increase of salt and particle concentrations.

Wang et al. (Langmuir 2010, 26(8), pages 5397-5404) disclose pickering emulsions stabilized by a lipophilic surfactant and hydrophilic platelike particles. Liquid paraffin-water emulsions were prepared by homogenizing oil phases containing sorbitan oleate (Span 80) and aqueous phases containing layered double hydroxide (LDH) particles or Laponite particles. While water-in-oil (w/o) emulsions are obtained by combining LDH with Span 80, the emulsions stabilized by Laponite-Span 80 are always o/w types regardless of the Span 80 concentration. Laser-induced fluorescent confocal micrographs indicate that particles are absorbed on the emulsion surfaces, suggesting all the emulsions are stabilized by the particles.

EP 0 557 089 A1 discloses sunscreen formulations comprising water, oil and layered double hydroxides.

Thus, there is a need to provide an emulsion that shows high stability, even at higher temperatures such as temperatures in the range of 30-300° C.

The object of the present invention is achieved by an emulsion comprising:

a) water,
b) at least one oil and
c) at least one layered double hydroxide of general formula (I)

[M^{II}₍₁₋ₓ₎M^{III}ₓ(OH)₂]^{x+}[Aⁿ⁻]_{x/n}·yH₂O (1),
wherein
M^{II} denotes a divalent metal ion or 2 Li,
M^{III} denotes a trivalent metal ion,
Aⁿ⁻ denotes at least one n-valent anion comprising:
(i) a mixture of A1 and A2, or
(ii) A1,
whereby
A1 is selected from the group consisting of alkyl sulfate, alkyl phosphate, alkyl sulfonate, alkyl phosphanate, alkyl phosphinate and alkyl carbonate, and
A2 is selected from the group consisting of H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
n is 1 to 4,
x is the mole fraction having a value ranging from 0.1 to 0.5 and
y is a value ranging from 0 to 5.0,
   whereby the layered double hydroxide of general formula (I) is present in the form of solid particles.

The object of the present invention is achieved by an emulsion comprising:

a) water,
b) at least one oil and
c) at least one layered double hydroxide of general formula (I)

[M^{II}₍₁₋ₓ₎M^{III}ₓ(OH)₂]^{x+}[Aⁿ⁻]_{x/n}·yH₂O (I),
wherein
M^{II} denotes a divalent metal ion or 2 Li,
M^{III} denotes a trivalent metal ion,
Aⁿ⁻ denotes at least one n-valent anion comprising:
(i) a mixture of A1 and A2, or
(ii) A1,
whereby
A1 is selected from the group consisting of alkyl sulfate, alkyl phosphate, alkyl sulfonate, alkyl phosphonate, alkyl phosphinate and alkyl carbonate, and
A2 is selected from the group consisting of COO⁻, C₂O₄²⁻, H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(ON)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
n is 1 to 4,
x is the mole fraction having a value ranging from 0.1 to 0.5 and
y is a value ranging from 0 to 5.0,
   whereby the layered double hydroxide of general formula (I) is present in the form of solid particles.

The object of the present invention is achieved by an emulsion comprising:

a) water,
b) at least one crude oil and
c) at least one layered double hydroxide of general formula (I)

[M^{II}₍₁₋ₓ₎M^{III}ₓ(OH)₂]^{x+}[Aⁿ⁻]_{x/n}·yH₂O (I),
wherein
M^{II} denotes a divalent metal ion or 2 Li,
M^{III} denotes a trivalent metal ion,
Aⁿ⁻ denotes at least one n-valent anion comprising:
(i) a mixture of A1 and A2, or
(ii) A1,
whereby
A1 is selected from the group consisting of alkyl sulfate, alkyl phosphate, alkyl sulfonate, alkyl phosphonate, alkyl phosphinate and alkyl carbonate, and
A2 is selected from the group consisting of COO⁻, C₂O₄²⁻, H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
n is 1 to 4,
x is the mole fraction having a value ranging from 0.1 to 0.5 and
y is a value ranging from 0 to 5.0,
   whereby the layered double hydroxide of general formula (I) is present in the form of solid particles.

### A BRIEF DESCRIPTION OF THE FIGURES

FIG. 1 is a SEM image which shows that the product is a disk shaped material with the diameter of around 50 nm, the thickness of 10-20 nm, and the aspect ratio of 2.5-5.

FIG. 2 is a SEM image which shows that the product is a disk shaped material with the diameter of 30-180 nm, the thickness of around 15 nm, and aspect ratio of 2-12.

The term “stability” or “stabilized” refers to the period up to incipient separation, and in which the emulsion does not visually show segregation, such as the formation of a visible bottom layer of water and/or a visible top layer of oil.

The term “valence” refers to the charge of A1 or A2. For example, the valence of CH₃COO⁻ is −1.

For evaluating the stability, as used in this invention, a test method is to be used wherein a sample of 100 g of emulsion is stored in a test tube with an inner diameter of 2.5 cm and sufficient length. The tube is stored at a selected temperature and monitored over time for separation to occur, i.e. for formation of a top or bottom layer. The stability is then the time elapsing between filling the test tube and the observation of the separation phenomenon. The temperature is to be chosen such that it is above the melting temperature of the compound in the emulsions with the highest melting temperature, and below the boiling temperature of the lowest boiling compound of the emulsion. Suitably it is chosen between 30° C. and 300° C.

The solid particles can arrange themselves at positions on the oil/water interface in a manner to prevent droplet coalescence, thus forming a stable emulsion. Preferably, the inventive emulsion shows a stability of 1 to 30 days at a temperature in the range of 30 to 200° C., more preferably a stability of 5 to 20 days at a temperature in the range of 30 to 200° C.

It is noted that WO 2009/87199 A1 discloses emulsions that contain oil, water and solid particles. However, these emulsions require the presence of surfactants in order to achieve sufficient stability of the emulsion. The use of surfactants is usually costly, because they cannot be recovered from the emulsion and subsequently be used again. Therefore, it would be very much appreciated if emulsions were provided that do not contain surfactants so that the solid particles can be recovered without any difficulty.

Hence, it is another object of the presently claimed invention to provide emulsions that show a high stability, even at higher temperatures such as temperatures in the range of 30-200° C. An alkyl (for Aⁿ⁻) can be a linear or branched, substituted or unsubstituted C₁-C₂₀-alkyl optionally interrupted by at least one heteroatom, at least partly halogenated, and/or at least partly hydroxylated, a linear or branched, substituted or unsubstituted C₄-C₁₈-alkyl optionally interrupted by at least one heteroatom, a substituted or unsubstituted C₃-C₂₀-cycloalkyl optionally attached via a linear or branched C₁-C₂₀-alkyl chain, a linear or branched, substituted or unsubstituted, at least monounsaturated C₂-C₂₀-alkenyl optionally interrupted by at least one heteroatom.

Heteroatoms usable in accordance with the invention are selected from N, O, P and S.

Preferably an alkyl is a linear or branched, substituted or unsubstituted C₁-C₂₀-alkyl, more preferably C₈-C₁₈-alkyl chain. In particular, an alkyl is a linear, unsubstituted C₁₄-C₁₈-alkyl, more particularly a linear, unsubstituted C₁₆-alkyl.

An emulsion according to the present invention is a heterogeneous liquid system involving two immiscible phases, with one of the phases being intimately dispersed in the form of droplets in the second phase. The matrix of an emulsion is called the external or continuous phase, while the portion of the emulsion that is in the form of droplets is called the internal, dispersed or discontinuous phase.

An emulsion according to the present invention can also be denoted as a fluid colloidal system in which liquid droplets and/or liquid crystals are dispersed in a liquid. The droplets often exceed the usual limits for colloids in size. An emulsion is denoted by the symbol O/W (or o/w), if the continuous phase is an aqueous solution and by W/O or (w/o), if the continuous phase is an organic liquid (an “oil”). More complicated emulsions such as O/W/O (i.e. oil droplets contained within aqueous droplets dispersed in the continuous oil phase) are also possible.

Preferably, the inventive emulsion is an o/w emulsion.

Apart from the conventional emulsions in which surface-active substances stabilize the emulsion, it is also possible to stabilize emulsion by solids.

These solid stabilized emulsions are characterized by the stabilization of the phase boundary with the help of (nano)particulate solid particles. These solids are not surface-active but form a mechanical barrier around the droplets of the internal phase and thus prevent their coalescence. In contrast to conventional emulsions, the use of emulsifiers is normally not necessary.

According to the IUPAC definition, emulsifiers are surfactants that stabilize emulsions by lowering the rate of aggregation and/or coalescence of the emulsions. Surface-active substances are located primarily in the interface between the oil and water phase to lower the interfacial tension.

The term “solid” means a substance in its most highly concentrated form, i.e., the atoms or molecules comprising the substance are more closely packed with one another relative to the liquid or gaseous states of the substance.

The “particle” of the present invention can have any shape, for example a spherical, cylindrical, a circular or cuboidal shape.

“Oil” means a fluid containing a mixture of condensable hydrocarbons of more than 90 wt.-%, preferably of more than 99 wt.-%. In particular “oil” can be defined as a mixture consisting of condensable hydrocarbons.

“Hydrocarbons” are organic material with molecular structures containing carbon and hydrogen.

Hydrocarbons may also include other elements, such as, but not limited to, halogens, metallic elements, nitrogen, oxygen, and/or sulfur.

A “mixture of A1 and A2” means that at least an anion A1 and an anion A2 are present in the at least one layered double hydroxide of general formula (I) (LDH). A1 and A2 are separate anions in the LDH, which can replace each other in the interlayer region of the LDH. In other words, the LDH can have two different anions located in the interlayer region. Preferably, Aⁿ⁻ denotes two anions. In order to maintain charge balance, the sum of the molar number of A1 divided by the valence of A1 and the molar number of A2 divided by the valence of A2 should be same as the molar number of trivalent metal ion, i.e. the ratio of the mixture of A1 and A2 is 1 mol [trivalent metal ion M^{III}]=(1 mol [A1]/valence of A1)+(1 mol [A2]/valence of A2).

Preferably the oils or hydrocarbons are selected from the group consisting of crude oil, straight and branched chain hydrocarbons having from 7 to 40 carbon atoms such as dodecane, isododecane, squalane, cholesterol, hydrogenated polyisobutylene, isododecosane, hexadecane; C₁-C₃₀ alcohol esters of C₁-C₃₀ carboxylic acids and of C₁-C₃₀ dicarboxylic acids such as isononyl isononanoate, methyl isostearate, ethyl isostearate, diisoproyl sebacate, diisopropyl adipate, isopropyl myristate, isopropyl palmitate, methyl palmitate, myristyl propionate, 2-ethylhexyl palmitate, isodecyl neopentanoate, di(2-ethylhexyl) maleate, cetyl palmitate, cetyl stearate, methyl stearate, isopropyl stearate, and behenyl behenate; mono-, di-, and tri-glycerides of C₁-C₃₀ carboxylic acids such as caprylic/capric triglyceride, PEG-6 caprylic/capric triglyceride, and PEG-8 caprylic/capric triglyceride; alkylene glycol esters of C₁-C₃₀ carboxylic acids including ethylene glycol mono- and diesters of C₁-C₃₀ carboxylic acids and propylene glycol mono- and diesters of C₁-C₃₀ carboxylic acids such as ethylene glycol distearate; C₁-C₃₀ mono- and polyesters of sugars and related materials such as glucose tetraoleate; and organopolysiloxane oils such as polyalkyl siloxanes, cyclic polyalkyl siloxanes, and polyalkylaryl siloxanes. It is also contemplated to use propoxylated or ethoxylated forms of the above-exemplified oils. It is further envisaged to use two or more oils as the oil component in the emulsion of the invention. It is further envisaged to use two or more crude oils as the crude oil component in the emulsion of the invention.

Preferably at least one layered double hydroxide is represented by the general formula (I)

[M^{II}₍₁₋ₓ₎M^{III}ₓ(OH)₂]^{x+}[Aⁿ⁻]_{x/n}·yH₂O (I),

wherein
M^{II} denotes a divalent metal ion or 2 Li,
M^{III} denotes a trivalent metal ion,
Aⁿ⁻ denotes at least one n-valent anion comprising:
(i) a mixture of A1 and A2, or
(ii) A1,
whereby
A1 is selected from the group consisting of alkyl sulfate, alkyl phosphate, alkyl sulfonate, alkyl phosphonate, alkyl phosphinate and alkyl carbonate, and
A2 is selected from the group consisting of COO⁻, C₂O₄²⁻, H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)_{4]}²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
n is 1 to 4,
x is the mole fraction having a value ranging from 0.1 to 0.5 and
y is a value ranging from 0 to 5.0.

Preferably, A2 is selected from the group consisting of C₂O₄²⁻, F⁻, Cl⁻, Br⁻, I⁻, OH⁻, NO₃⁻, ClO₄⁻, HPO₄²⁻, [Fe(CN)₆]³, [Fe(CN)₆]⁴⁻, CO₃²⁻ and SO₄²⁻. More preferably A2 is selected from the group consisting of Cl⁻, Br⁻, OH⁻, NO₃⁻, CO₃²⁻ and SO₄²⁻.

Preferably x is the mole fraction having a value ranging from 0.2 to 0.33.

Preferably, the divalent ion Mo is selected from the group consisting of Ca, Mg, Fe, Ni, Zn, Co, Cu or Mn.

Preferably, the trivalent ion M^{III} is selected from the group consisting of Al, Fe, Cr or Mn.

Preferably, the emulsion comprises:

a) 10 to 90% by weight water,
b) 10 to 90% by weight of at least one crude oil and
c) 0.1 to 10% by weight of at least one layered double hydroxide of general formula (I)

[M^{II}₍₁₋ₓ₎M^{III}ₓ(OH)₂]^{x+}[Aⁿ⁻]_{x/n}·yH₂O (I),
wherein
M^{II} denotes a divalent metal ion or 2 Li,
M^{III} denotes a trivalent metal ion,
Aⁿ⁻ denotes at least one n-valent anion comprising:
(i) a mixture of A1 and A2, or
(ii) A1,
whereby
A1 is selected from the group consisting of alkyl sulfate, alkyl phosphate, alkyl sulfonate, alkyl phosphonate, alkyl phosphinate and alkyl carbonate, and
A2 is selected from the group consisting of COO⁻, C₂O₄²⁻, H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
n is 1 to 4,
x is the mole fraction having a value ranging from 0.1 to 0.5 and
y is a value ranging from 0 to 5.0,
   whereby the layered double hydroxide is present in the form of solid particles,
   whereby the droplets of the emulsion have an average droplet size Dv₅₀ in the range of 1 to 13 μm determined according to ISO13320: 2010-01.

Preferably, the divalent ion M^{II} is selected from the group consisting of Ca, Mg, Fe, Ni, Zn, Co, Cu or Mn.

Preferably, the trivalent ion MIN is selected from the group consisting of Al, Fe, Cr or Mn.

Preferably, the emulsion comprises:

a) 50 to 90% by weight water,
b) 10 to 50% by weight crude oil and
c) 0.1 to 5% by weight at least one layered double hydroxide of general formula (I),

[M^{II}₍₁₋ₓ₎M^{III}ₓ(OH)₂]^{x+}[Aⁿ⁻]_{x/n}·yH₂O (I),

wherein
M^{II} denotes a divalent metal ion or 2 Li,
M^{III} denotes a trivalent metal ion,
Aⁿ⁻ denotes at least one n-valent anion comprising:
(i) a mixture of A1 and A2, or
(ii) A1,
whereby
A1 is selected from the group consisting of alkyl sulfate, alkyl phosphate, alkyl sulfonate, alkyl phosphonate, alkyl phosphinate and alkyl carbonate, and
A2 is selected from the group consisting of H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
   n is 1 to 4,
   x is the mole fraction having a value ranging from 0.1 to 0.5 an
   y is a value ranging from 0 to 5.0,
   whereby the layered double hydroxide is present in the form of solid particles,
   whereby the droplets of the emulsion have an average droplet size Dv₅₀ in the range of 1 to 13 μm determined according to ISO13320: 2010-01.

Preferably, the divalent ion M^{II} is selected from the group consisting of Ca, Mg, Fe, Ni, Zn, Co, Cu or Mn.

Preferably, the trivalent ion M^{III} is selected from the group consisting of Al, Fe, Cr or Mn.

Preferably, the emulsion comprises:

a) 50 to 90% by weight water,
b) 10 to 50% by weight crude oil and
c) 0.1 to 5% by weight at least one layered double hydroxide of general formula (I),

[M^{II}₍₁₋ₓ₎M^{III}ₓ(OH)₂]^{x+}[Aⁿ⁻]_{x/n}·yH₂O (I),

wherein
M^{II} denotes Mg,
M^{III} denotes a trivalent metal ion selected from the group consisting of Mn and Fe,
Aⁿ⁻ denotes hexadecyl sulfate,
x is the mole fraction having a value ranging from 0.1 to 0.5 and
y is a value ranging from 0 to 5.0,
whereby the layered double hydroxide is present in the form of solid particles,
whereby the droplets of the emulsion have an average droplet size Dv₅₀ in the range of 1 to 13 μm determined according to ISO13320: 2010-01.

Layered double hydroxides of general formula (I) (LDH) comprise an unusual class of layered materials with positively charged layers and charge balancing anions located in the interlayer region. This is unusual in solid state chemistry: many more families of materials have negatively charged layers and cations in the interlayer spaces (e.g. kaolinite, Al₂Si₂O₅(OH)₄).

The layered double hydroxide (LDH) of general formula (I) according to the present invention can be obtained by the reaction of a layered double hydroxide of general formula (IA) and the salt of an alkyl sulfate, alkyl phosphate, alkyl sulfonate, alkyl carboxylate, alkyl phosphonate, alkyl phosphinate and alkyl carbonate, whereby the cation is selected from alkali metals, alkaline earth metals and rare earth metals or mixtures thereof.

Preferably the LDH of formula (I) can be obtained by mixing, for example by sonication, the salt of an alkyl sulfate, alkyl phosphate, alkyl sulfonate, alkyl carboxylate, alkyl phosphonate, alkyl phosphinate and alkyl carbonate, whereby the cation is selected from alkali metals, alkaline earth metals and rare earth metals or mixtures thereof and a layered double hydroxide of general formula (IA), optional in the presence of an acid. In particular, the acid can be HNO₃.

Examples of the at least one layered double hydroxide of general formula (IA) include hydrotalcite [Mg₆Al₂(CO₃)(OH)₁₆.4(H₂O)], manasseite [Mg₆Al₂(CO₃)(OH)₁₆.4(H₂O)], pyroaurite [Mg₆Fe₂(CO₃)(OH)₁₆.4.5 (H₂O)], sjoegrenite [Mg₆Fe₂(CO₃)(OH)₁₆.4.5(H₂O)], stichtite [Mg₆Cr₂(CO₃)(OH)₁₆.4(H₂O)], barbertonite [Mg₆Cr₂(CO₃)(OH)₁₆.4(H₂O)], takovite, reevesite [Ni₆Fe₂(CO₃)(OH)₁₆.4(H₂O)], desautelsite [Mg₆Mn₂(CO₃)(OH)₁₆CO₃.4(H₂O)], motukoreaite, wermlandite, meixnerite, coalingite, chlormagaluminite, carrboydite, honessite, woodwardite, iowaite, hydrohonessite and mountkeithite. More preferably the at least one layered double hydroxide of general formula (I) is selected from the group consisting of hydrotalcite [Mg₆Al₂(CO₃)(OH)₁₆.4(H₂O)], manasseite [Mg₆Al₂(CO₃)(OH)₁₆.4(H₂O)], pyroaurite [Mg₆Fe₂(CO₃)(OH)₁₆.4.5(H₂O)], sjoegrenite [Mg₆Fe₂(CO₃)(OH)₁₆.4.5(H₂O)], stichtite [Mg₆Cr₂(CO₃)(OH)₁₆.4(H₂O)], barbertonite [Mg₆Cr₂(CO₃)(OH)₁₆.4(H₂O)], takovite, reevesite [Ni₆Fe₂(CO₃)(OH)₁₆.4(H₂O)] and desautelsite [Mg₆Mn₂(CO₃)(OH)₁₆CO₃.4(H₂O)]. More preferably the at least one layered double hydroxide is selected from the group consisting of hydrotalcite [Mg₆Al₂(CO₃)(OH)₁₆.4(H₂O)], manasseite [Mg₆Al₂(CO₃)(OH)₁₆.4(H₂O)], pyroaurite [Mg₆Fe₂(CO₃)(OH)₁₆.4.5(H₂O)] and sjoegrenite [Mg₆Fe₂(CO₃)(OH)₁₆.4.5 (H₂O)].

The present invention is further elucidated by the following embodiments and preferred embodiments. They may be combined freely unless the context clearly indicates otherwise.

In a preferred embodiment of the inventive emulsion the divalent ion M^{II} is selected from the group consisting of Ca, Mg, Fe, Ni, Zn, Co, Cu or Mn.

In a preferred embodiment of the inventive emulsion the trivalent ion M^{III} is selected from the group consisting of Al, Fe, Cr or Mn. In particular M^{III} is selected from the group consisting of Fe, Cr or Mn.

In a preferred embodiment of the inventive emulsion, the emulsion is a solid particles-stabilized emulsion.

In a preferred embodiment of the inventive emulsion, A1 is selected from the group consisting of alkyl sulfate and alkyl phosphate and A2 is selected from the group consisting of CO₃²⁻ and Cl⁻. Preferably, A1 is alkyl sulfate and A2 is CO₃²⁻.

In a preferred embodiment of the inventive emulsion A1 is an alkyl sulfate selected from the group consisting of octyl sulfate, decyl sulfate, dodecyl sulfate, tetradecyl sulfate, hexadecyl sulfate and octadecyl sulfate. Preferably, A1 is selected from the group consisting of tetradecyl sulfate, hexadecyl sulfate and octaclecyl sulfate. More preferably, A1 is hexadecyl sulfate.

In a preferred embodiment of the inventive emulsion, the emulsion comprises 9.9 to 90.0% by weight water, 10.0 to 90.0% by weight of at least one oil and 0.1 to 10.0% by weight of at least one layered double hydroxide of general formula (I) related to the overall weight of the emulsion. Preferably the emulsion comprises 49.9 to 90.0% by weight water, 10.0 to 50.0% by weight oil and 0.1 to 5.0% by weight of at least one layered double hydroxide of general formula (I), most preferably 69.9 to 90.0% by weight water, 10.0 to 30.0% by weight oil and 0.1 to 2.5% by weight of at least one layered double hydroxide of general formula (I), in each case related to the overall weight of the emulsion.

In a preferred embodiment of the inventive emulsion, the emulsion comprises 9.9 to 90.0% by weight water, 10.0 to 90.0% by weight of at least one crude oil and 0.1 to 10.0% by weight of at least one layered double hydroxide of general formula (I) related to the overall weight of the emulsion. Preferably the emulsion comprises 49.9 to 90.0% by weight water, 10.0 to 50.0% by weight crude oil and 0.1 to 5.0% by weight of at least one layered double hydroxide of general formula (I), most preferably 69.9 to 90.0% by weight water, 10.0 to 30.0% by weight crude oil and 0.1 to 2.5% by weight of at least one layered double hydroxide of general formula (I), in each case related to the overall weight of the emulsion.

In a preferred embodiment of the inventive emulsion, the solid particles are delaminated by the treatment with an alcohol at a temperature in the range from 50° C. to 100° C. for 1 h to 30 h. Preferably, the solid particles are delaminated at a temperature in the range from 60° C. to 90° C. for 5 to 25 h. In particular, the solid particles are delaminated at a temperature in the range from 60° C. to 80° C. for 15 h to 25 h. Delamination means to separate the two layers of an LDH into two separate layers. Therefore, the anions are contained in both separate layers. Preferably, the alcohol is a 01-C₆-alcohol, more preferably butanol.

Most preferably the oil is crude oil having an API gravity in the range between 20° API and 40° API. Such oils, by nature of their composition, usually contain asphaltenes and polar hydrocarbons. API gravity is defined as following formula by the American Petroleum Institute: API gravity=(141.5/Specific Gravity) 131.5, where specific gravity is a ratio of the density of oil to the density of a reference substance, usually water, and is always determined at 60 degrees Fahrenheit.

“Crude oil” is defined as a mixture of hydrocarbons that existed in liquid phase in underground reservoirs and remains liquid at atmospheric pressure after passing through surface separating facilities and which has not been processed through a crude oil distillation tower.

The emulsions disclosed herein are preferably used to recover crude oil. Such oils, by nature of their composition, usually contain sufficient asphaltenes and polar hydrocarbons, which will help stabilize the solid particles-stabilized emulsion.

In a preferred embodiment of the inventive emulsion, the emulsion has a viscosity at 20° C. in the range of 5 to 30 mPa·s under shear rate of 10/s determined according to DIN 53019-1:2008-09. Preferably, the emulsion has a viscosity in the range of 5 to 20 mPa·s under shear rate of 10/s determined according to DIN 53019-1:2008-09.

The solid particles are made of layered double hydroxide of general formula (I). The actual average particle size should be sufficiently small to provide adequate surface area coverage of the internal oil phase.

In a preferred embodiment of the inventive emulsion the solid particles have an average particle size in the range of 30 nm to 10 μm determined according to SEM. Preferably, the particles have an average particle size in the range of 30 nm to 2 μm and more preferably in the range of 50 nm to 100 nm, determined according to SEM images (as defined under Method A).

Preferably, the solid particles have a BET surface area in the range of 50 to 400 m²/g, more preferably in the range of 80 to 130 m²/g, according to DIN 66131: 1993-06 at 77 K.

Preferably, the solid particles remain undissolved in the water phase under the inventively used conditions, but have appropriate charge distribution for stabilizing the interface between the internal droplet phase, i.e. oil, and the external continuous phase, i.e. water, to make a solid particles-stabilized oil-in-water emulsion.

Preferably, the solid particles are hydrophilic for making an oil-in-water emulsion. Thereby, the particles are properly wetted by the continuous phase, i.e. water that holds the discontinuous phase. The appropriate hydrophilic character may be an inherent characteristic of the solid particles or either enhanced or acquired by treatment of the solid particles.

In the scope of the present invention, “hydrophilic” means that the surface of a corresponding “hydrophilic” solid particle has a contact angle with water against air of <90°. The contact angle is determined according to methods that are known to the skilled artisan, for example using a standard-instrument (Dropshape Analysis Instrument, Fa. Kruss DAS 10). A shadow image of the droplet is taken using a CCD-camera, and the shape of the droplet is acquired by computer aided image analysis. These measurements are conducted according to DIN 5560-2.

In a preferred embodiment of the inventive emulsion, the droplets in the emulsion have an average droplet size Dv₅₀ in the range of 1 to 13 μm determined according to ISO13320: 2010-01. Preferably, the droplets in the emulsion have an average droplet size Do in the range of 2 to 10 μm and more preferably in the range of 3 to 8 μm, determined according to ISO13320:2010-01. Dv₅₀ is defined as the volume median diameter at which 50% of the distribution is contained in droplets that are smaller than this value while the other half is contained in droplets that are larger than this value.

Preferably the droplets in the emulsion have an average droplet size Dv₉₀ in the range of 10 to 40 μm, more preferably in the range of 12 to 30 μm and most preferably in the range of 14 to 20 μm, determined according to ISO13320:2010-01. Dv₉₀ is defined as the diameter at which 90% of the distribution is contained in droplets that are smaller than this value while 10% is contained in droplets that are larger than this value.

Preferably, the water used for making the solid particles-stabilized emulsion contains ions. Preferably, the total ion concentration is in the range of 3000 to 300 000 mg/l, more preferably the total ion concentration is in the range of 150 000 to 250 000 mg/l, most preferably the total ion concentration is in the range of 160 000 to 200 000 mg/l. Water having an ion concentration in the range of 3000 to 300 000 mg/l is referred to as salt water in the sense of the presently claimed invention.

Preferably, the water used for making the solid particles-stabilized emulsion has conductivity in the range of 8 mS/cm to 300 mS/cm, more preferably in the range of 54 mS/cm to 300 mS/cm, most preferably in the range of 150 to 250 mS/cm.

The conductivity is a measure of the level of ion concentration of a solution. The more salts, acids or bases are dissociated, the greater the conductivity of the solution. In water or waste water it is mainly a matter of the ions of dissolved salts, and consequently the conductivity is an index of the salt load in water. The measurement of conductivity is generally expressed in S/cm (or mS/cm) which is the product of the conductance of the test solution and the geometric factor of the measuring cell. Conductivity can be measured using a variety of commercially available test instruments such as the Waterproof PC 300 hand-held meter made by Eutech Instruments/Oakton Instruments.

In a preferred embodiment of the inventive emulsion, at least one oil has a viscosity in the range of 1 to 5000 mPa·s at a temperature of 20° C. according to DIN 53019-1:2008-09. Preferably, the oil has a viscosity in the range of 500 to 4000 mPa·s at a temperature of 20° C., more preferably a viscosity of 1000 to 3000 mPa·s at a temperature of 20° C. according to DIN 53019-1:2008-09.

In a preferred embodiment of the inventive emulsion, at least one crude oil has a viscosity in the range of 1 to 5000 mPa·s at a temperature of 20° C. according to DIN 53019-1:2008-09. Preferably, the crude oil has a viscosity in the range of 500 to 4000 mPa·s at a temperature of 20° C., more preferably a viscosity of 1000 to 3000 mPa·s at a temperature of 20° C. according to DIN 53019-1:2008-09.

In a preferred embodiment of the inventive emulsion,

the divalent metal ion is Ca, Mg, Fe, Ni, Zn, Co, Cu or Mn,
the trivalent metal ion is Al, Fe, Cr or Mn,
A1 is an alkyl sulfate and A2 is CO₃²⁻.

In a preferred embodiment of the inventive emulsion, the emulsion has conductivity in the range of 1 to 275 mS/cm. Preferably, the emulsion has a conductivity in the range from 10 to 260 mS/cm, more preferably in the range of 80 to 250 mS/cm. In particular, the conductivity in the range from 50 to 190 mS/cm can correspond to a concentration of the n-valent anion selected from the group consisting of alkyl sulfate and alkyl phosphate, alkyl sulfonate, alkyl carboxylate, alkyl phosphonate, alkyl phosphinate and alkyl carbonate at a concentration in the range from 5 to 100 mM.

In a preferred embodiment of the inventive emulsion, the layered double hydroxide of general formula (I) is positive charged. A positive charge is denoted as the total of all negative and positive charges in the layered double hydroxide of general formula (I), whereby the sum is positive.

In a preferred embodiment of the inventive emulsion the aspect ratio of the solid particles is in the range from 1 to 30 determined according to SEM images. Preferably, the aspect ratio is in the range of 1 to 20, most preferably in the range of 1 to 10, even more preferably in the range of 2 to 8, whereby the aspect ratio is defined as diameter/thickness. The diameter and the thickness are determined according to SEM images (as defined under Method A).

In a preferred embodiment of the inventive emulsion the amount of A1 on the external layer of the at least one layered double hydroxide of general formula (I) is in the range from 0 mM (corresponds to millimole) to 0.1 mM (corresponds to millimole). Preferably, the range is from 0 mM to 0.01 mM. More preferably, the amount of A1 is zero.

The external layer is the opposite side of the internal layer of the layered double hydroxide. In other words, in the sandwich structure of an layered double hydroxide and the anions (LDH(upper layer)-Anion-LDH(lower layer)) the two external sides of the at least one layered double hydroxide of general formula (I) have an amount of A1 in the range from 0 mM to 0.1 mM.

Preferably, A1 is not in contact with the at least one layered double hydroxide of general formula (I) by (physical) adsorption. Preferably, A1 is in contact with the at least one layered double hydroxide of general formula (I) by ion-exchange.

The present invention is also directed to a process for the preparation of an emulsion comprising the step of stirring a mixture comprising a) water, b) at least one oil and c) at least one layered double hydroxide of general formula (I) as define above at a temperature in the range of 30 to 300° C. for a period in the range of 1 min to 2 hours.

The present invention is also directed to a process for the preparation of an emulsion comprising the step of stirring a mixture comprising a) water, b) at least one crude oil and c) at least one layered double hydroxide of general formula (I) as define above at a temperature in the range of 30 to 300° C. for a period in the range of 1 min to 2 hours.

Preferably the temperature is in the range of 40 to 150° C., more preferably in the range of 50 to 100° C.

Preferably the period is in the range of 1 to 90 min, more preferably in the range of 10 to 80 min.

The solid particles are added in an amount that is sufficient to stabilize an oil-in-water emulsion. Preferably, the solid particles are added in an amount of 0.01 to 10 g in relation to 100 ml water, more preferably in amount of 0.01 to 5.0 g in relation to 100 ml water, most preferably in an amount of 0.01 to 2.5 g in relation to 100 ml water, i.e. water containing preferably 0.01 to 10 weight-%, more preferably 0.01 to 5.0 weight-%, most preferably 0.01 to 2.5 weight-% solid particles is added.

The present invention is also directed to the use of the inventive emulsion for enhanced oil recovery. Preferably used emulsions have already been mentioned above.

The emulsions of the invention can preferably be used in any application for which they are suitable. Examples of such applications include use in cosmetics, drilling for oil and gas, enhanced oil recovery, food, agricultural chemicals, emulsion polymers or latexes, pharmaceuticals, and asphalt emulsions or asphaltic bitumen emulsions. Depending on the use of the emulsion, it can comprise further ingredients, which may either be oil-soluble or water-soluble. For instance, when used in agro formulations, the emulsion suitably contains an agrochemically active compound. This can be the oil itself or any substance dissolved in the emulsion, such as biocides (including herbicides, fungicides, and pesticides), fertilizers, and the like. Said substance, or each substance when using a combination of substances, can be dissolved in any one of both phases. Similarly, e.g. for cosmetics, the emulsions can contain one or more additional compounds, such as perfumes, vitamins, and the like, dissolved in one or both phases, or as the oil component itself. More preferably the emulsions of the invention are used for enhanced oil recovery.

In a preferred embodiment, the inventively claimed emulsion comprises:

a) water having conductivity in the range of 8 mS/cm to 300 mS/cm,
b) at least one crude oil and
c) at least one layered double hydroxide of general formula (I)

[M^{II}₍₁₋ₓ₎M^{III}ₓ(OH)₂]^{x+}[Aⁿ⁻]_{x/n}·yH₂O (I),
wherein
M^{II} denotes a divalent metal ion or 2 Li,
M^{III} denotes a trivalent metal ion,
Aⁿ⁻ denotes at least one n-valent anion comprising:
(i) a mixture of A1 and A2, or
(ii) A1,
whereby
A1 is selected from the group consisting of alkyl sulfate, alkyl phosphate, alkyl sulfonate, alkyl phosphonate, alkyl phosphinate and alkyl carbonate, and
A2 is selected from the group consisting of COO⁻, C₂O₄²⁻, H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
n is 1 to 4,
x is the mole fraction having a value ranging from 0.1 to 0.5 and
y is a value ranging from 0 to 5.0,
whereby the layered double hydroxide of general formula (I) is present in the form of solid particles.

In a more preferred embodiment, the inventively claimed emulsion comprises:

a) water having conductivity in the range of 8 mS/cm to 300 mS/cm,
b) at least one crude oil and
c) at least one layered double hydroxide of general formula (I)

[M^{II}₍₁₋ₓ₎M^{III}ₓ(OH)₂]^{x+}[Aⁿ⁻]_{x/n}·yH₂O (I),
wherein
M^{II} denotes a divalent metal ion or 2 Li,
M^{III} denotes a trivalent metal ion,
Aⁿ⁻ denotes at least one n-valent anion comprising:
(i) a mixture of A1 and A2, or
(ii) A1,
whereby
A1 is selected from the group consisting of alkyl sulfate, alkyl phosphate, alkyl sulfonate, alkyl phosphonate, alkyl phosphinate and alkyl carbonate, and
A2 is selected from the group consisting of Cl⁻, Br⁻, OH⁻, NO₃⁻, CO₃²⁻ and SO₄²⁻,
whereby
the ratio of the mixture of A1 and A2 is 1 mol [trivalent metal ion M^{III}]=(1 mol [A1]/valence of A1)+(1 mol [A2]/valence of A2),
n is 1 to 4,
x is the mole fraction having a value ranging from 0.1 to 0.5 and
y is a value ranging from 0 to 5.0,
whereby the layered double hydroxide of general formula (I) is present in the form of solid particles.

The preferred embodiments of practicing the invention have been described. It should be understood that the foregoing is illustrative only and that other means and techniques can be employed without departing from the true scope of the invention claimed herein.

### EXAMPLES

### Methods

### Emulsion Characterization

### Type

The type of emulsion (oil in water type or water in oil type) was determined by conductivity measurement.

After 24 hours from making an emulsion, the conductivity of emulsion was measured with a conductivity meter (LF330, Wissenschaftlich-Technische Werkstätten GmbH). When conductivity of an emulsion is more than 10 μS/cm, it indicates that the emulsion is oil in water type. When conductivity of an emulsion is less than 10 μS/cm, it indicates that the emulsion is water in oil type (Langmuir 2012, 28, 6769-6775).

### Droplet Size

Droplet size of emulsion was measured by the laser diffraction in accordance to ISO13320: 2010-01. The value of Dv₅₀ was used for comparison.

N₂ adsorption desorption isotherms: Langmuir surface areas, BET surface areas, micropore volume, pore volume, micropore size were measured via nitrogen adsorption at 77 K according to DIN 66131: 1993-06 (BET) and DIN 66135-1: 2001-06 (N2 adsorption). The micropore volume was determined from the t-plot analysis.

X-ray powder diffraction: The determinations of the crystallinities were performed on a D8 Advance series 2 diffractometer from Bruker AXS. The diffractometer was configured with an opening of the divergence aperture of 0.1° and a Lynxeye detector. The samples were measured in the range from 2° to 70° (2 Theta). After baseline 30 correction, the reflecting surfaces were determined by making use of the evaluation software EVA (from Bruker AXS). The ratios of the reflecting surfaces are given as percentage values.

### SEM

Powder samples were investigated with the field emission scanning electron microscope (FESEM) Hitachi S-4700, which was typically run at acceleration voltages between 2 kV and 20 kV. Powder samples were prepared on a standard SEM stub and sputter coated with a thin platinum layer, typically 5 nm. The sputter coater was the Polaron SC7640. The sizes of LDH particles, diameter and thickness, were counted manually from SEM images. 50 particles were picked up randomly, and their sizes were measured. The averages were defined by the particle sizes. Aspect ration was determined as the ration of diameter/thickness.

### Elemental Analysis

Composition of the obtained materials is measured with flame atomic absorption spectrometry (F-AAS) and inductively coupled plasma optical emission spectrometry (ICP-OES).

### AFM

The heights of the particles are measured with atomic force microscopy (AFM). The AFM measurement was performed on Bruker ICON Peak Force Mapping at 1 nN. Bruker MPP-12120-10 Model TAP150A was used as a cantilever. Scan frequency was 0.3 Hz. Typically, 5 mg of powder was dispersed in 8 ml of EtOH (dry, Aldrich) with 10 minutes of ultrasonic sound. Then the suspension was dropped onto a freshly cleaved Mica surface and dried under vacuum at room temperature.

### FT-IR Analysis

The functional groups of samples are observed with FT-IR. The FT-IR measurements were performed on a Nicolet 6700 spectrometer with KBr method. Typically, 1 mg of sample and 300 mg of KBr were mixed and grinded in agate mortar, and the mixture was press with 80 kN. The spectra were recorded in the range of 4000 cm⁻¹ to 400 cm⁻¹ at a resolution of 2 cm⁻¹. The obtained spectra were represented by a plot having on the x axis the wavenumber (cm⁻¹) and on the y axis the absorbance (arbitrary units).

### Preparation of Layered Double Hydroxides (LDH)

### Example 1

### Synthesis of Hydrotalcite (Mg²⁺, Al³⁺, CO₃²⁻) (for Comparative Purpose)

Solution A: Mg(NO₃)₂.6H₂O and Al (NO₃)₃.9H₂O were dissolved in deionized water (562.5 ml).

Solution B: NaOH and Na₂CO₃ were dissolved in deionized water (562.5 ml) to form the mixed base solution. Solution A (562.5 ml) and solution B (562.5 ml) were simultaneously added (5 sec.) under stirring to a vessel containing deionized water (450 ml). The pH of the reaction mixture was around 8.55-8.6. The mixing process was carried out at room temperature. The resulting slurry was transferred to an autoclave and aged at 100° C. for 13 h while stirring (150 U/min). The pH of resulting slurry was 8.38. The slurry was filtered, washed well with 23 L of deionized water, and dried at 120° C. overnight.

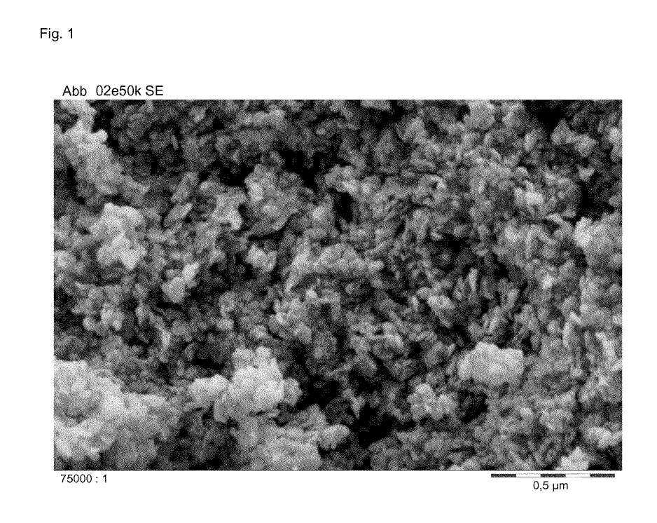

The characterization of the final product by XRD as shown in table 1 shows that the product has the typical layered double hydroxide structure. The SEM image (FIG. 1) shows that the product is a disk shaped material with the diameter of around 50 nm, the thickness of 10-20 nm, and the aspect ratio of 2.5-5. The elemental analysis indicated an elemental composition of Mg (23.0 wt. %) and Al (8.2 wt. %). The N2 adsorption isotherm measurements indicated that the material has BET surface area of 106.3 m²/g. The AFM observation indicated that the average height of the particles was 20 nm (height in a range of 15˜24 nm were observed).

TABLE 1

| Number | Angle | d-Spacing | Rel. Intensity |
|---|---|---|---|
| 1 | 11.30 | 7.82 | 100% |
| 2 | 15.20 | 5.83 | 3% |
| 3 | 22.82 | 3.89 | 77% |
| 4 | 26.84 | 3.32 | 3% |
| 5 | 30.72 | 2.91 | 5% |
| 6 | 34.43 | 2.60 | 59% |
| 7 | 38.48 | 2.34 | 29% |
| 8 | 45.54 | 1.99 | 26% |
| 9 | 60.36 | 1.53 | 70% |
| 10 | 61.63 | 1.50 | 69% |
| 11 | 65.42 | 1.43 | 12% |

### Example 2

### Synthesis of Hydrotalcite-Like Compound (Mg²⁺, Fe³⁺, CO₃²⁻) (for Comparative Purpose)

Solution A: Mg(NO₃)₂.6H₂O and Fe (NO₃)₃.9H₂O were dissolved in deionized water (562.5 ml).

Solution B: NaOH and Na₂CO₃ were dissolved in deionized water (562.5 ml) to form the mixed base solution. Solution A (562.5 ml) and solution B (562.5 ml) were simultaneously added dropwise to a vessel containing stirred deionized water (450 ml). The pH of the reaction mixture was around 10.6. The mixing process was carried out at room temperature. The resulting slurry was transferred to autoclave and aged at 100° C. for 13 h with 150 U/min stirring. The pH of resulting slurry was 9.5. The slurry was washed well with deionized water with normal filter, and dried at 120° C. overnight.

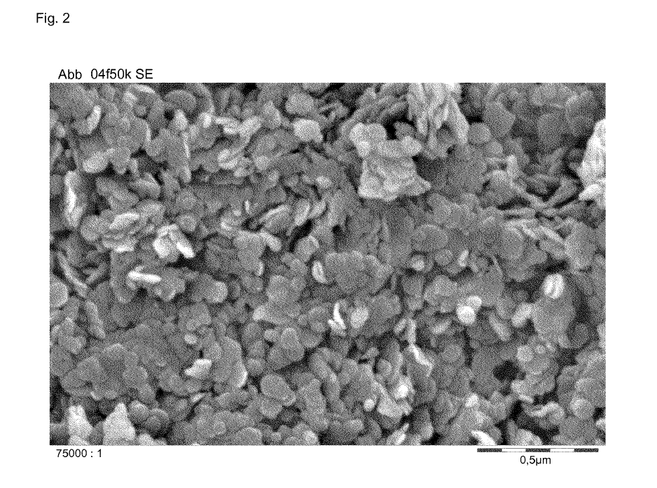

The characterization of the final product by XRD as shown in table 2 shows that the product has the typical layered double hydroxide structure characteristic. The SEM image (FIG. 2) shows that the product is a disk shaped material with the diameter of 30-180 nm, the thickness of around 15 nm, and aspect ratio of 2-12. The elemental analysis indicated an elemental composition of Mg (21.7 wt. %) and Fe (12.6 wt. %). The N2 adsorption isotherm measurements indicated that the material has BET surface area of 71.0 m²/g. The AFM observation indicated that the average height of the particles was 21 nm (heights in a range of 11-33 nm were observed).

TABLE 2

| Number | Angle | d-Spacing | Rel. Intensity |
|---|---|---|---|
| 1 | 11.24 | 7.87 | 100% |
| 2 | 15.20 | 5.82 | 6% |
| 3 | 22.67 | 3.92 | 75% |
| 4 | 26.83 | 3.32 | 2% |
| 5 | 30.76 | 2.90 | 7% |
| 6 | 34.00 | 2.63 | 44% |
| 7 | 38.29 | 2.35 | 24% |
| 8 | 45.51 | 1.99 | 20% |
| 9 | 59.38 | 1.56 | 78% |
| 10 | 60.66 | 1.53 | 77% |
| 11 | 64.42 | 1.45 | 15% |

### Ion Exchange of LDHs

The typical procedure for the ion-exchange is as follows: LDH (3.6 g) and the required amount of sodium alkyl sulfates/phosphates were dispersed in distilled water (180 mL) and 10% HNO₃ (7 ml) was added. The mixture was sonicated for 30 minutes and then heated at 50° C. for 2 h, under stirring at 100 rad/s. A molar ratio of surfactant: LDH=1.7-14.1*10⁻²:1. The resulting slurry was filtered in a nitrogen atmosphere, washed with distilled water and a small amount of ethanol. The product was dried in vacuum at 50° C.

### Example 3

### Layered Double Hydroxide (Mg²⁺, Al³⁺, CO₃²⁻) was Ion-Exchanged with Sodium Dodecyl Sulfate

A molar ratio of surfactant: LDH=2.5*10⁻²:1. Ion-exchange was confirmed with elemental analysis, FT-IR analysis, and AFM observation: The elemental analysis indicated an elemental composition of sulfur with 0.21 wt. % (ca. 76% of sodium dodecyl sulfate was ion-exchanged, calculated based on sulfur contents); FT-IR analysis indicated C—H stretches at 2854 cm⁻¹ and 2924 cm⁻¹; and the AFM observation indicated that the average height of the particles was 34 nm (heights in a range of 33-34 nm were observed).

### Example 4

### Layered Double Hydroxide (Mg²⁺, Fe³⁺, CO₃²⁻) was Ion-Exchanged with Sodium 1-Propanesulfonate Monohydrate

A molar ratio of surfactant: LDH=2.6*10⁻²:1. Ion-exchange was confirmed with elemental analysis and FT-IR analysis: The elemental analysis indicated an elemental composition of sulfur with <0.01 wt. % (ca. <4.8% of sodium 1-propanesulfonate monohydrate was ion-exchanged, calculated based on sulfur contents); and FT-IR analysis indicated C—H stretches at 2949 cm⁻¹ and 2973 cm⁻¹.

### Example 5

### Layered Double Hydroxide (Mg²⁺, Fe³⁺, CO₃²⁻) was Ion-Exchanged with Sodium Octyl Sulfate

A molar ratio of surfactant: LDH=2.6*10⁻²:1. Ion-exchange was confirmed with elemental analysis and FT-IR analysis: The elemental analysis indicated an elemental composition of sulfur with 0.02 wt. % (ca. 9.6% of sodium octyl sulfate was ion-exchanged, calculated based on sulfur contents); and FT-IR analysis indicated C—H stretches at 2921 cm⁻¹ and 2957 cm⁻¹.

### Example 6

### Layered Double Hydroxide (Mg²⁺, Fe³⁺, CO₃²⁻) was Ion-Exchanged with Sodium Dodecyl Sulfate

A molar ratio of surfactant: LDH=3.5*10⁻²:1. Ion-exchange was confirmed with elemental analysis, FT-IR analysis, and AFM observation: The elemental analysis indicated an elemental composition of sulfur with 0.22 wt. % (ca. 79% of sodium dodecyl sulfate was ion-exchanged, calculated based on sulfur contents); FT-IR analysis indicated C—H stretches at 2854 cm⁻¹ and 2924 cm⁻¹; and the AFM observation indicated that the average height of the particles was 28 nm (heights in a range of 21-35 nm were observed).

### Example 7

### Layered Double Hydroxide (Mg²⁺, Fe³⁺, CO₃²⁻) was Ion-Exchanged with Sodium Hexadecyl Sulfate

A molar ratio of surfactant: LDH=5.1*10⁻²:1. Ion-exchange was confirmed with elemental analysis and FT-IR analysis: The elemental analysis indicated an elemental composition of sulfur with 0.43 wt. % (ca. 100% of sodium hexadecyl sulfate was ion-exchanged, calculated based on sulfur contents); and FT-IR analysis indicated C—H stretches at 2851 cm⁻¹ and 2920 cm⁻¹.

### Example 8

### Layered Double Hydroxide (Mg²⁺, Fe³⁺, CO₃²⁻) was Ion-Exchanged with Sodium Monododecyl Phosphate (Mixture of Mono and Disodium Salt)

A molar ratio of surfactant: LDH=3.5*10⁻²:1. Ion-exchange was confirmed with elemental analysis and FT-IR analysis: The elemental analysis indicated an elemental composition of phosphorus with 0.01 wt. % (ca. 3.9% of sodium monododecyl phosphate was ion-exchanged, calculated based on sulfur contents); and FT-IR analysis indicated C—H stretches at 2850 cm⁻¹ and 2918 cm⁻¹.

### Example 9

### Layered Double Hydroxide (Mg²⁺, Fe³⁺, CO₃²⁻) was Ion-Exchanged with Sodium Hexadecyl Sulfate

A molar ratio of surfactant: LDH=3.4*10⁻²:1. Ion-exchange was confirmed with elemental analysis and FT-IR analysis: The elemental analysis indicated an elemental composition of sulfur with 0.26 wt. % (ca. 100% of sodium hexadecyl sulfate was ion-exchanged, calculated based on sulfur contents); and FT-IR analysis indicated C—H stretches at 2851 cm⁻¹ and 2919 cm⁻¹.

### Preparation of Emulsions

For evaluating the obtained materials as emulsifier, emulsion test was performed on the inventive LDHs of example 1-8 as well as on sodium dodecyl sulfate and sodium hexadecyl sulfate. The condition of emulsion test is as follows:

1 g of powder and 10 ml of mineral oil (PIONIER 1912, H&R Vertrieb GmbH, 31.4 mPa·s at 20° C.) were added to 90 ml of salt water. The suspension was heated at 60° C. for 1 hour with stirring. After heating, the suspension was stirred with Ultra-turrax with 15*103 rpm for 3 minutes. Salt water was obtained by dissolving 56429.0 mg of CaCl₂.2H₂O, 22420.2 mg of MgCl₂.6H₂O, 132000.0 mg of NaCl, 270.0 mg of Na₂SO₄, and 380.0 mg of NaBO₂.4H₂O to 1 L of deionized water, adjusting pH to 5.5-6.0 with HCl afterwards. The total ion concentration of the salt water was 185 569 mg/L. The conductivity of the salt water was 216 mS/cm.

### Emulsion 1

### Emulsion for Comparative Example

The compositions of emulsion 1 are as follows: 1 g of layered double hydroxide (Mg²⁺, Al³⁺, CO₃²⁻) from example 1, 10 ml of mineral oil (PIONIER 1912, H&R Vertrieb GmbH, 31.4 mPa·s at 20° C.), and 90 ml of salt water.

The conductivity of this emulsion was 148 mS/cm which indicates that this emulsion is oil in water type. The result of laser diffraction indicates that this emulsion has Dv₅₀ of 13.6 μm.

### Emulsion 2

The compositions of emulsion 2 are as follows: 1 g of modified layered double hydroxide (Mg²⁺, Al³⁺, CO₃²⁻) from example 3, 10 ml of mineral oil (PIONIER 1912, H&R Vertrieb GmbH, 31.4 mPa·s at 20° C.), and 90 ml of salt water.

The conductivity of this emulsion was 144 mS/cm which indicates that this emulsion is oil in water type. The result of laser diffraction indicates that this emulsion has Dv₅₀ of 8.63 μm.

### Emulsion 3

### Emulsion for Comparative Example

The compositions of emulsion 3 are as follows: 1 g of layered double hydroxide (Mg²⁺, Fe³⁺, CO₃²⁻) from example 2, 10 ml of mineral oil (PIONIER 1912, H&R Vertrieb GmbH, 31.4 mPa·s at 20° C.), and 90 ml of salt water.

The conductivity of this emulsion was 151 mS/cm which indicates that this emulsion is oil in water type. The result of laser diffraction indicates that this emulsion has Dv50 of 13.7 μm.

### Emulsion 4

The compositions of emulsion 4 are as follows: 1 g of modified layered double hydroxide (Mg²⁺, Fe³⁺, CO₃²⁻) from example 4, 10 ml of mineral oil (PIONIER 1912, H&R Vertrieb GmbH, 31.4 mPa·s at 20° C.), and 90 ml of salt water.

The conductivity of this emulsion was 11.87 mS/cm which indicates that this emulsion is oil in water type. The result of laser diffraction indicates that this emulsion has Dv₅₀ of 13.6 μm.

### Emulsion 5

The compositions of emulsion 5 are as follows: 1 g of modified layered double hydroxide (Mg²⁺, Fe³⁺, CO₃²⁻) from example 5, 10 ml of mineral oil (PIONIER 1912, H&R Vertrieb GmbH, 31.4 mPa·s at 20° C.), and 90 ml of salt water.

The conductivity of this emulsion was 2.84 mS/cm which indicates that this emulsion is oil in water type. The result of laser diffraction indicates that this emulsion has Dv₅₀ of 12.4 μm.

### Emulsion 6

The compositions of emulsion 6 are as follows: 1 g of modified layered double hydroxide (Mg²⁺, Fe³⁺, CO₃²⁻) from example 6, 10 ml of mineral oil (PIONIER 1912, H&R Vertrieb GmbH, 31.4 mPa·s at 20° C.), and 90 ml of salt water.

The conductivity of this emulsion was 150 mS/cm which indicates that this emulsion is oil in water type. The result of laser diffraction indicates that this emulsion has Dv₅₀ of 8.51 μm.

### Emulsion 7

The compositions of emulsion 7 are as follows: 1 g of modified layered double hydroxide (Mg²⁺, Fe³⁺, CO₃²⁻) from example 7, 10 ml of mineral oil (PIONIER 1912, H&R Vertrieb GmbH, 31.4 mPa·s at 20° C.), and 90 ml of salt water.

The conductivity of this emulsion was 22.1 mS/cm which indicates that this emulsion is oil in water type. The result of laser diffraction indicates that this emulsion has Dv₅₀ of 6.55 μm.

### Emulsion 8

The compositions of emulsion 8 are as follows: 1 g of modified layered double hydroxide (Mg²⁺, Fe³⁺, CO₃²⁻) from example 8, 10 ml of mineral oil (PIONIER 1912, H&R Vertrieb GmbH, 31.4 mPa·s at 20° C.), and 90 ml of salt water.

The conductivity of this emulsion was 255 mS/cm which indicates that this emulsion is oil in water type. The result of laser diffraction indicates that this emulsion has Dv₅₀ of 12.0 μm.

### Emulsion 9

### Emulsion for Comparative Example

The compositions of emulsion 9 are as follows: 1 g of sodium dodecyl sulfate, 10 ml of mineral oil (PIONIER 1912, H&R Vertrieb GmbH, 31.4 mPa·s at 20° C.), and 90 ml of salt water.

The outcome was not an emulsion but two phases with oil and water.

### Emulsion 10

### Emulsion for Comparative Example

The compositions of emulsion 10 are as follows: 0.043 g of sodium hexadecyl sulfate, 10 ml of mineral oil (PIONIER 1912, H&R Vertrieb GmbH, 31.4 mPa·s at 20° C.), and 90 ml of salt water.

The outcome was not an emulsion but two phases with oil and water.

### Emulsion 11

The compositions of emulsion 11 are as follows: 1 g of modified layered double hydroxide (Mg²⁺, Fe³⁺, CO₃²⁻) from example 9, 10 ml of crude oil (Bockstedt oil, Wintershall, 6 mPa·s at 20° C. according to DIN 53019-1:2008-09), and 90 ml of salt water.

The conductivity of this emulsion was 217 mS/cm which indicates that this emulsion is oil in water type. The result of laser diffraction indicates that this emulsion has Dv₅₀ of 12.9 μm.

### Emulsion 12

The compositions of emulsion 12 are as follows: 1 g of modified layered double hydroxide (Mg²⁺, Fe³⁺, CO₃²⁻) from example 6, 10 ml of crude oil (Emlicheim oil, Wintershall, 13 mPa·s at 20° C. according to DIN 53019-1:2008-09), and 90 ml of salt water.

The conductivity of this emulsion was 158 mS/cm which indicates that this emulsion is oil in water type. The result of laser diffraction indicates that this emulsion has Dv50 of 13.1 μm.

### Stability and Permeability of the Emulsions

### Sand-Packed Column Experiments

Flow of the emulsion through porous media, i.e. sandstone or packed sand is essential for practical application. The following experiments allow us to examine the permeability of the obtained emulsion.

A cylinder with height of 200 mm and diameter of 15 mm was used for a vessel. Sand provided by Wintershall (Well: Bockstedt-83) was put into the cylinder until its height be 100 mm. The sand was not pretreated with water and/or oil. After that, 50 ml of emulsion was poured into the cylinder with 20 ml/min. The amounts of emulsion which went through the sand and droplet size of the emulsion were used as a measure of the ability of the emulsion to flow through the packed column without destruction of the emulsion.

### Example 1 (Comparative)

The sand-packed column experiment was carried out with emulsion 1 as described above. 31.4% of the emulsion was recollected after passing through the column.

### Example 2

The sand-packed column experiment was carried out with emulsion 2 as described above. 73.5% of the emulsion was recollected after passing through the column.

### Example 3 (Comparative)

The sand-packed column experiment was carried out with emulsion 3 as described above. 57.6% of the emulsion was recollected after passing through the column.

### Example 4

The sand-packed column experiment was carried out with emulsion 7 as described above. <99.9% of the emulsion was recollected after passing through the column.

1.-17. (canceled)

18. An emulsion comprising:
a) water,
b) at least one crude oil and
c) at least one layered double hydroxide of general formula (I)
[M^{II}₍₁₋ₓ₎M^{III}ₓ(OH)₂]^{x+}[Aⁿ⁻]_{x/n}·yH₂O (I),
wherein
M^{II} denotes a divalent metal ion or 2 Li,
M^{III} denotes a trivalent metal ion,
Aⁿ⁻ denotes at least one n-valent anion comprising:
(i) a mixture of A1 and A2, or
(ii) A1,
wherein
A1 is selected from the group consisting of alkyl sulfate, alkyl phosphate, alkyl sulfonate, alkyl phosphonate, alkyl phosphinate and alkyl carbonate, and
A2 is selected from the group consisting of COO⁻, C₂O₄²⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
wherein
the ratio of the mixture of A1 and A2 is 1 mol [trivalent metal ion M^{III}]=(1 mol [A1]/valence of A1)+(1 mol [A2]/valence of A2),
n is 1 to 4,
x is the mole fraction having a value ranging from 0.1 to 0.5 and
y is a value ranging from 0 to 5.0,
wherein the layered double hydroxide of general formula (I) is present in the form of solid particles.

19. The emulsion according to claim 18, wherein the water has a total ion concentration in the range of 3000 to 300 000 mg/1.

20. The emulsion according to claim 18, wherein the divalent ion M^{II} is selected from the group consisting of Ca, Mg, Fe, Ni, Zn, Co, Cu and Mn.

21. The emulsion according to claim 18, wherein the trivalent ion M^{III} is selected from the group consisting of Al, Fe, Cr and Mn.

22. The emulsion according to claim 18, wherein the emulsion is a solid particles-stabilized emulsion.

23. The emulsion according to claim 18, wherein A1 is selected from the group consisting of alkyl sulfate and alkyl phosphate and A2 is selected from the group consisting of Cl⁻, Br⁻, OH⁻, NO₃⁻, CO₃²⁻ and SO₄²⁻.

24. The emulsion according to claim 18, wherein A1 is selected from the group consisting of alkyl sulfate and alkyl phosphate and A2 is selected from the group consisting of CO₃²⁻ and Cl⁻.

25. The emulsion according to claim 18, wherein A1 is an alkyl sulfate selected from the group consisting of octyl sulfate, decyl sulfate, dodecyl sulfate, tetradecyl sulfate, hexadecyl sulfate and octadecyl sulfate.

26. The emulsion according to claim 18, wherein the emulsion comprises 9.9 to 90% by weight water, 10 to 90% by weight of at least one crude oil and 0.1 to 10% by weight of at least one layered double hydroxide of general formula (I), related to the overall weight of the emulsion.

27. The emulsion according to claim 18, wherein the emulsion has a viscosity at 20° C. in the range of 5 to 30 mPa·s under shear rate of 10/s according to DIN 53019-1:2008-09.

28. The emulsion according to claim 18, wherein the solid particles have an average particle size in the range of 30 nm to 10 μm determined according to SEM.

29. The emulsion according to claim 18, wherein the droplets of the emulsion have an average droplet size Dv₅₀ in the range of 1 to 13 μm determined according to ISO13320: 2010-01.

30. The emulsion according to claim 18, wherein the at least one crude oil has a viscosity in the range of 1 to 5000 mPa·s at a temperature of 20° C. according to DIN 53019-1:2008-09.

31. The emulsion according to claim 18, wherein
the divalent metal ion is Ca, Mg, Fe, Ni, Zn, Co, Cu or Mn,
the trivalent metal ion is Al, Fe, Cr or Mn,
A1 is an alkyl sulfate and A2 is CO₃²⁻.

32. The emulsion according to claim 18, wherein the emulsion has a conductivity in the range of 1 to 275 mS/cm.

33. A process for the preparation of an emulsion according to claim 18, comprising the step of stirring a mixture comprising a) water, b) at least one crude oil and c) at least one layered double hydroxide of general formula (I) according to claim 18 at a temperature in the range of 30 to 300° C. for a period in the range of 1 min to 2 hours.

34. A process for enhanced oil recovery which comprises utilizing the emulsion according to claim 18.
